(19) United States
(12) Patent Application Publication
(10) Pub. No.: US 2003/0208428 A1
(43) Pub. Date: Nov. 6, 2003

(54) Inverse solution for structured finance

(76) Inventors: Sylain Raynes, Jackson Heights, NY (US); Ann E. Rutledge, Jackson Heights, NY (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/130,902

(22) PCT Filed: Sep. 26, 2001
(86) PCT No.: PCT/US01/30074

(51) Int. Cl. G06F 17/60

(52) U.S. Cl. 705/36

(57) ABSTRACT

A method of solving the inverse problem through an iterative process is provided whereby each iterative effectively solves one forward problem without having to sample the entire non-linear space. This method is a selective and iterative process for optimizing many variables that substantially achieves a global optimum solution. One particular process utilizes a neo-Darwinism method. Under this method, the sample space is iteratively analyzed via “mutations” to the value of the variable involved. Starting from a basic structure, assumed sub-optimal, we apply small variations or mutations are applied to each variable in turn, and those that are determined to improve the outcome value are kept. A better outcome value is determined to exist when a set of ratings is closer to the required set. Because the average rating is an invariant, the variable space is operated on throughout the process of looking for the combination of factors that will lead to the better outcome value.

### CROSS REFERENCE TO RELATED APPLICATIONS

This application claims priority under 35 U.S.C. §119(e) to provisional patent application serial No. 60/235,780 filed Sep. 26, 2000, the disclosure of which is hereby incorporated by reference.

### STATEMENT REGARDING FEDERALLY SPONSORED RESEARCH OR DEVELOPMENT

N/A

### BACKGROUND OF THE INVENTION

Structured finance is a financing technique whereby specific assets are placed in a trust, thereby isolating them from the bankruptcy risk of the entity that originated them. Structured finance is known to be a market in which all parties rely to a great extent on the ratings and rating announcements to understand the credit risks and sources of protection in structured securities (of which there are many types, asset-backed commercial paper (ABCP), asset-backed securities (ABS), mortgage-backed securities (MBS), collateralized bond obligation (CBO), collateralized loan obligation (CLO), collateralized debt obligation (CDO), structured investment vehicles (SIV), and derivatives products company (DPC), synthetic CLOs, CBOs of ABS, collectively “structured finance.”)

Structured financings are typically the result of the sale of receivables to a special purpose vehicle created solely for this purpose. Securities backed by the receivables in the pool (“asset pool”) are then issued. These are normally separated into one or more “tranches” or “classes”, each with its own characteristics and payment priorities. Having different payment priorities, the tranches accordingly have different risk profiles and payment expectations as a function of the potential delinquencies and defaults of the various receivables and other assets in the pool. The senior tranche usually has the lowest risk.

In structured finance, rating agencies are usually faced with what is known as the “forward problem.” Various asset-based structures proposed by investment banks are rated, but restructuring solutions are not proposed because sufficient compensation for the time and potential liability of providing such solutions are not available.

Bankers, investors and analysts want to achieve a given set of ratings known in advance to be salable into the capital markets, but sufficient information regarding the ratings process is generally not available to provide guidance for the desired outcome. The rating process is therefore iterative, time-consuming and opaque to the bankers and the analysts. As a result, bankers and rating analysts exchange various re-incarnations of the asset-backed structure in the hope to “converge” to the requested ratings.

The basic characteristic of structured finance is that it is a zero-sum game in its purest form. In this context, it means that, in a world where multiple securities are issued out of one asset pool, it is by definition impossible to make one security holder better off without making another worse off because both share in a single set of cash flows. The only way to make both security holders better off simultaneously is to assume that the aggregate cash flow to be expected from the pool of assets is somehow better than previously thought. Accordingly, bankers, analysts and investors desire to solve the problem of structuring deals already rated or the “inverse problem.”

A major stumbling block of optimization within structured finance is the fact that the rating of a structured finance security is given by the average reduction of yield that security would experience over the universe of possibilities to be expected from asset performance. If it is also assumed that the “ergodic” hypothesis holds, i.e. that temporal averages are equal to ensemble averages, then the same reduction of yield would be experienced by an investor holding a well diversified portfolio of similarly rated securities.

A non-linearity of the yield results from the fact that the yield function is a non-linear function, being the solution r to the following equation: I=ΣᵢC(t(i))/(1+r)^{t(i)}, where C(t(i)) is the cash flow experienced at time t(i) and I is the initial investment. This non-linearity causes local optima to be globally sub-optimal in a multi-dimensional space. The result is that we cannot optimize one variable at a time and that we require a more sophisticated technique. If the entire multi-dimensional space of many variables is explored, the analysis of the number of possible values will quickly exhaust the capabilities of even the fastest computer. It is therefore desirable to provide a method for solving the inverse problem in a fast and efficient manner by minimizing the necessary computational resources.

### BRIEF SUMMARY OF THE INVENTION

A method of solving the inverse problem through an iterative process is disclosed whereby each iterative effectively solves one forward problem without having to sample the entire non-linear space. This method is a selective and iterative process for optimizing many variables that substantially achieves a global optimum solution. More particularly, one such process comprises a neo-Darwinism method. Under this method, the sample space is iteratively analyzed via “mutations” to the value of the variable involved. Starting from a basic structure, assumed sub-optimal, small variations or mutations, are applied to each variable in turn, and those that are determined to improve the outcome value are kept. A better outcome value is determined to exist when a set of ratings is within a predetermined range of an average rating. Because the average rating is an invariant, the variable space is operated on throughout the process of looking for the combination of factors that will lead to the better outcome value.

Other aspects, features and advantages of the present invention are disclosed in the detailed description that follows.

### BRIEF DESCRIPTION OF THE SEVERAL VIEWS OF THE DRAWING

The invention will be more fully understood by reference to the following detailed description of the invention in conjunction with the drawings, of which:

FIG. 1 illustrates a process for determining the inverse solution problem according to an embodiment of the present invention;

FIG. 2 illustrates a flow chart of a process for solving the inverse solution problem according to another embodiment of the present invention; and

FIG. 3 illustrates a computer system for performing the processes according to the embodiments of the present invention.

### DETAILED DESCRIPTION OF THE INVENTION

The method of solving the inverse problem according to the embodiments of the present invention utilizes an iterative process. Each iterative effectively solves one forward problem without having to sample the entire non-linear space. As a result, the method according to the present invention substantially achieves a global optimum solution by optimizing the many variables.

The first step in solving the inverse problem is to determine the average rating of the securities in the transaction, or the “feasible range.” This step is performed as a consequence of the average rating of asset-backed securities being approximately constant for a given set of cash flow histories from the pool. The average rating is approximately constant because non-linearity in the yield curve will still introduce arbitrage possibilities of a second order as compared to the zero-sum game condition.

Because the average rating is an “invariant” of the structure under such assumptions, if this average rating is less than the average required rating, the problem will turn out to be “ill-posed,” a mathematical concept that boils down to the realization that the problem as stated has no solution. This average is known from the very first iteration and this important condition can be enforced without any optimization. Thereby, one or many of the initial conditions must be altered to solve the inverse problem which is ill-posed. A non-exhaustive set of examples of the independent factors and conditions that may be altered are shown below in Table I.

TABLE I

1. Reduction or increase in tranche size
(such that the sum remains invariant).
2. Introduction of a spread capture trigger
into the structure where cash was formerly
allowed to escape, or where the trigger
reapportions cash between the tranches.
3. Introduction of a reserve account or
another form of credit enhancement.
4. Changes in the waterfall from sequential
to pari passu or from pro rata and pari passu
to pan passu but not pro rata.
5. Subordinate tranche lockout periods.
6. Various forms of asset-based or
liability-based triggers.
7. Servicing fee subordination where
appropriate.
8. Senior tranche “turbo” mechanism upon
breaching a trigger.
9. Other structure finance factors and
conditions.

Once it is realized that the problem is ill-posed, the next step is to reduce total issuance until the “well-posed-ness” condition is satisfied. When that happens, we can move on to the optimization properly said.

It is appreciated that many other types of enhancements, factors or structural features can be introduced into asset-backed transactions. It is also realized that the introduction of a reserve account can raise the rating of each class since it effectively increases the available cash over the life of the deal. Optimality will result if doing so, taking into account the cost of setting aside this cash at closing, would improve the combination of the average ratings and the issuer's net position through a possible arbitrage of the rating and yield scales.

After a “feasible range” has been determined as previously discussed, the inverse solution proceeds by exploring each factor in turn within its range of possible variations while introducing small disturbances in the remaining factors in search for a globally optimal solution. These small variations can be exploited through the neo-Darwinian solution method described in more detail hereinafter to achieve global optimality. Due to the non-linearity of the yield curve, it will generally be possible to achieve a slightly better result than a “feasible solution” found during the first step.

Although there is no guarantee that a global optimum will actually be found, each new iterate will be analyzed to determine whether its result is better than the existing result. If the “mutation” provides a better result, the existing result will be replaced with the result yielded by the new iterate, otherwise the “mutation” will be discarded. The solution procedure can then be halted at any time to retrieve the current optimal structure. Each factor in the list above is to be placed inside an iterative loop within which “mutated” levels are sampled. Each set of factors is then fed to the forward solution process for producing a set of results to be compared with the required set. The forward solution can be halted when a predetermined “figure of merit” is reached which can be stated in terms of a total cost of issuance, a total issued amount, maximum proceeds or some combination of these factors or others.

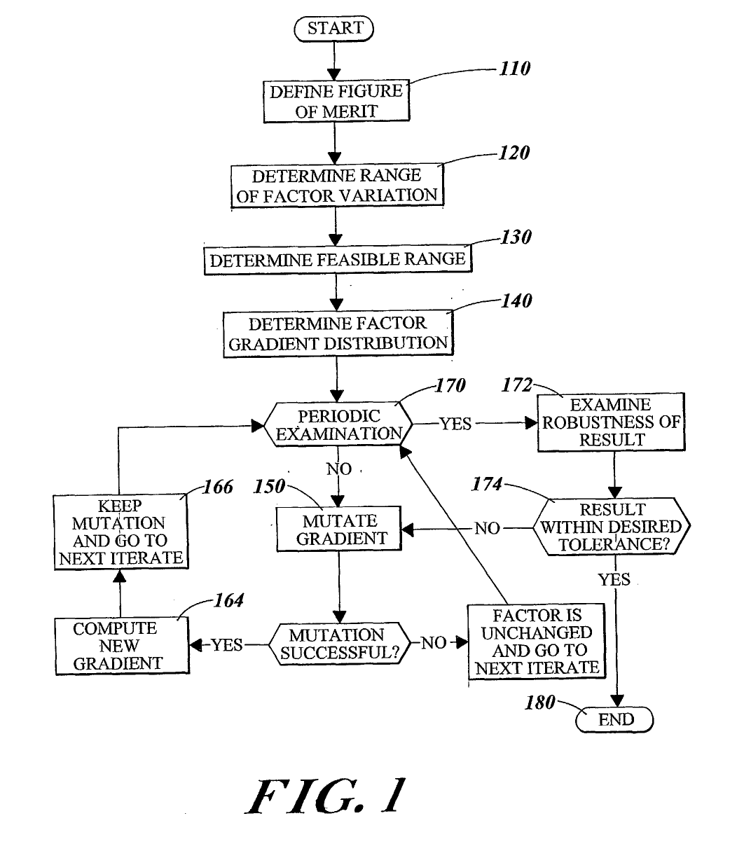

FIG. 1 illustrates a stepwise flowchart for a neo-Darwinism solution method according to an embodiment of the present invention. In step 110, a figure of merit for the transaction is defined in coordination with the issuer. In one example, the metric for determining this figure of merit is obtained by computing the average cost of issuance, the total proceeds or a weighted combination thereof. Next, a determination is made at step 120 for the range of allowable variation for each factor and the range is normalized to embed it into a Binomial or another statistical distribution of discrete values. The mean of that distribution is determined so as to advantage the most likely a priori range for the factor.

At step 130, a trial structure is obtained based on the prior transaction or a similar transaction executed by a comparable issuer. Using a trial issuance above the feasible range, usually limited by the condition of zero over-collateralization, the average tranche rating is computed. If the average tranche rating is below the required set, the issuance is reduced. If the average tranche rating is above the required set, the issuance is increased until the discrepancy between the required and actual average is within a prescribed tolerance.

The figure of merit for each factor is determined at step 140 for two levels separated by a small distance, so that the gradient of the structure is established in that direction. The range from 0 to 1 is partitioned into a probability distribution function given by the relative gradient probability distribution for the factors. In other words, a factor with a large gradient will give rise to more frequent sampling of that factor, and vice versa. In practice, this procedure guarantees that the currently most sensitive factor is advantaged during the optimization without excluding the other factors completely.

At step 150, a non-linear space “loop structure” is entered. Each factor (listed generically as factor 1, factor 2, etc.) is mutated in turn with the requirement that the mutation is preserved if it leads to a higher figure of merit. Factor sampling uses the Binomial distribution defined above and the inverse cumulative distribution function method. The next iterate is defined as the previous iterate plus the Binomial factor increase. It is appreciated that Binomial factor may be negative which indicates a Binomial factor decrease.

If a mutation is determined to be successful at step 160, the relevant factor is retained at that value until its next mutation. If the mutation is determined not to be successful at step 160, the factor value before the mutation is retained and another factor is tried at step 162. Thereafter, the gradient is re-computed each time for the factor that was mutated if success was achieved and the gradient probability distribution is re-normalized for the factor selection at step 164. The factor value from the mutation is retained before proceeding to the next iterate at step 166. More generally, a standard optimization method such as the steepest descent or Newton-Raphson method may be used to accelerate the search for the global optimum. The challenge is to find the optimum combination of factors keeping in mind that a factor thought to be optimal at some level may turn out to be sub-optimal when other factors have been altered. Each set of factor levels necessitates the solution of a forward problem. Each such solution requires the analysis of the exact structural details of the transaction, many of which may have changed since the last iteration.

The solution procedure is halted periodically or after many cycles at step 170. The resulting structure is examined for robustness by mutating each factor in turn using a larger difference at step 172. Thereafter, a determination is made at step 174 as to whether the range of possible improvement using one factor at a time variations is smaller than a specified value. If the criterion is satisfied, the method is stopped at step 180. Otherwise, the method proceeds to the loop structure at step 150.

In one specific example of a method for solving the inverse solution problem according to an embodiment of the present invention, there will be an initial figure of merit generated which will set the desired outcome for each issuer for the investment in pooled assets. For example, one set of situations may be for early cash returns while another may be for maximum overall returns. Armed with this information, a desired or target rating and interest rate for each component or tranche of the investors can be set. Statistical analysis is then used to test the investment according to cash flow models of the financial institutions, typically insurance companies or retirement funds, making the investments and to determine how closely the investment can be tailored to fit those targets. Because the cash flow models cannot be solved for the desired output, information of the tranche rating, an iterative approach is undertaken as is known in the art by varying the output until convergence to the actual input factors is achieved.

The factors or variables available for adjustment in the effort to reach the targets are various and may change for each deal. One set of typical and non-limiting factors is shown in Table I. It is to be clearly understood that other factors may be selected due to the ability to control them for different deals.

With a set of factors available, the cash flow model is provided with starting values for each of the factors. Consider one such factor to be the size of each tranche in a two-tranche deal. Because the level of risk and possible level of gain is different for each tranche, typically one of little risk and one of high risk but great potential, there will be a greater size for the lower risk tranche and a smaller size for the riskier one for a number of reasons not the least of which is the availability of accurate information on the probability of a high return. For exemplary purposes only a starting point for the tranche size factor could then be 90/10 for lower/higher risk respectively. Initial values for the other factors will also be selected.

The analysis begins by first running a statistical analysis of the cash flow model for the initial factor value selections. Then one factor is varied. Assuming it is the tranche size, it could typically be varied by 0.5, to say 90.5/9.5. The statistical iterative analysis is run again and the result is normally a different set of ratings for each tranche. The first factor is then returned to its prior value and another factor varied and the statistical iteration is converged again. This is repeated for all the factors and at that point a gradient is established as the slope of the curve represented by the cash flow model at those initial factor values.

The process is then repeated, moving each factor in the direction of the gradient. When this is accomplished, presumably the ratings will have improved. Where the determined gradient is large, a steep slope, it may be desirable to make the step changes in the factors large so as to speed up the process. This is desirable because the process of convergence is very lengthy for even very fast computers given the number of factors and the need to have multiple evaluations for the convergence operation to reach an accurate end result.

Eventually a peak or maximum in the tranche ratings will result. However, given the complex non-linearity of the cash flow models, this may be only a local maximum. To account for this possibility, one of the factors is given a relatively large value change and the entire process is rerun to find a new local maximum. This large step of mutation is then repeated for each factor, not just once but as many times as the available time for computation will allow. Because of the huge time requirements, it may not be possible to assess all local maxima in order to find the best. Similarly no maximum may be high enough to justify the deal.

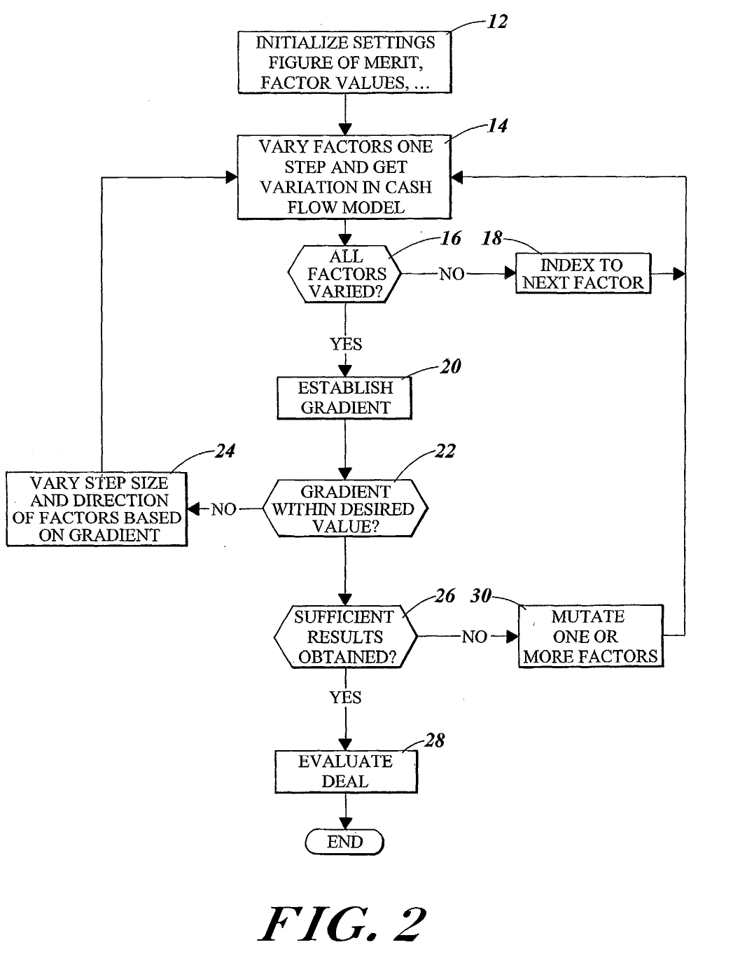

FIG. 2 shows the invention diagramatically in the form of a flow chart. While most of the steps are computer executed, several like the initializing step 12 and final determination steps are done by human means. The initializing step 12 accomplishes the formulation of the figure of merit and target ratings for the deal along with the number and approximate risk, starting values for the factors, and participation rules for the tranches. Computer execution begins in step 14 using the applicable cash flow model(s) and comprises an iterative determination of the effect on the ratings as defined in the cash flow model from a one step move (out and back) in a first (or next) one of the several factors. Once that is done, a decision step 16 determines whether all of the factors has experienced the one step evaluation of step 14. If the determination is that not all the factors have been moved, a subsequent step 18 indexes or advances to the next factor in the list and returns processing to step 14. As can be seen this accomplishes a one-step move in all the factors and provides the change in the rating information for each.

When all the factors have executed this one-step and back move from the initial (or current) values, a subsequent step 20 establishes the gradient in the rating information for the various changes in factor value for each move. This is in effect a partial differential over each of the factors. Subsequent step 22 is a decision for whether the process to this point has reached a suitable conclusion. Normally the process will loop through this decision many times with a no determination, returning to the step 14 for another round of factor steps. The step size and direction is a function of the gradient so the iterative analysis moves each factor toward a higher or preferred rating outcome as determined in a step 24. If the gradient is steep, the process may increase the step size.

If the gradient is small enough or time is short, decision 22 may decide that the process had progressed far enough and progress to step 26 where a determination is further made as to whether it is time to quit the process and live with the results obtained or go further by mutating the factors. If the step 26 determines the process is finished, it proceeds to a deal evaluation step in step 28 that is largely human powered. But if the process is not yet done, a step 30 mutates one or more factors by stepping them a large distance compared to the small steps that had been taken previously in the changes of factor value. The step size is large enough to give a high probability of moving out of the region of slope of a local maximum about which the cash flow model was used to reach to or nearly to the local maximum. The step is of a size that it is likely, though not certain to reach the region of a separate local maximum that may be higher or lower. The mutation may by one, several or all factors at a time. After the mutation, the entire process is repeated leading to finding the local maximum for the ratings by iterative analysis of the cash flow model(s).

This process of mutation will also be made many times in the process of deal evaluation leading to several maxima and thus allowing selection of the highest or one of the highest thereof. As can be seem there is an enormous amount of calculation going forth in this process given the iterative nature of the models involved and the need to repeat the entire procedure a great many time for each maximum to be found. Only high capability computation equipment can be used for this to be done efficiently.

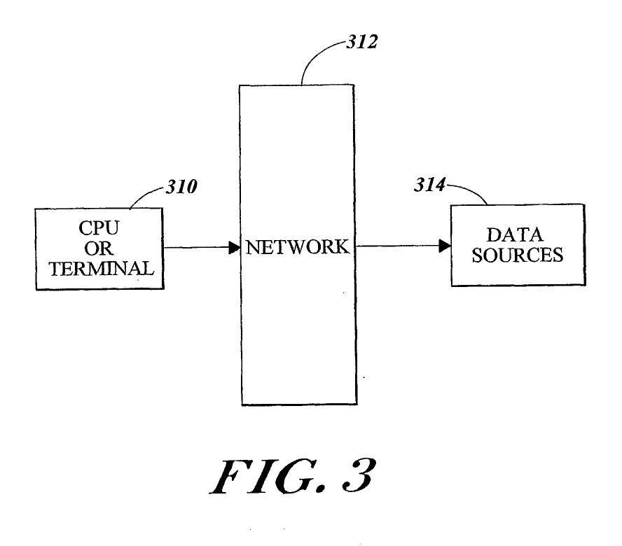

The invention is typically performed in a powerful computer environment given the number of iterations that are performed. As such, one or more CPUs or terminals 310 are provided as an I/O device for a network 312 including distributed CPUs, sources and internet connections appropriate to receive the data from sources 314 used in these calculations as illustrated in FIG. 3 in an embodiment of the present invention.

It will be apparent to those skilled in the art that other modifications to and variations of the above-described techniques are possible without departing from the inventive concepts disclosed herein. Accordingly, the invention should be viewed as limited solely by the scope and spirit of the appended claims.

What is claimed is:

1. A method for analyzing a financial investment characterized by at least one issuer, at least one investor, one or more tranches, and a plurality of variable factors, the method comprising the steps of:
establishing a figure of merit as a target for the financial investment and a starting value for a set of some or all of said factors; and
iteratively calculating the effect on investment rating for a predetermined step change in said set of some or all of said plurality of factors using a cash flow model to determine at least a local maximum for the rating.

2. The method of claim 1 wherein said iteratively calculating step further includes:
making a step change in each of said factors in said set;
determining a gradient in the rating as a function of each factor in said set; and
repeating the iterative calculation with step changes in the direction of said gradient for each of said factors in said set.

3. The method of claim 1 or 2 wherein said iteratively calculating step includes the steps of:
after determination of said local maximum, making a change, in one or more factors of said set, sufficient for subsequent iterative calculations to reach a different local maximum; and
making said subsequent iterative calculations to reach said different local maximum.

4. The method of claim 3 further including the step of repeating said step of making said subsequent iterative calculations steps one or more times.

5. The method of claim 4 wherein said repetition of said step of making said subsequent iterative calculations is terminated after an operator decision to stop said method.

6. The method of anyone of claims 2 to 5 wherein said step of iteratively calculating determines the local maximum as a condition wherein said gradient is below a predetermined level.

7. The method of anyone of claims 1 to 6 wherein said set includes all of said factors.

8. The method of anyone of claims 1 to 7 wherein each change in factor value is a function of a local gradient.

9. The method of anyone of claims 1 to 8 wherein there are plural tranches.

10. A method for giving advise on an investment rating comprising the steps of:
receiving information about the investment; and
obtaining investment rating information resulting from performing the steps of anyone of claims 1 to 9.

11. A method for assessing a rating of a structured finance transaction associated with a pool of assets and defined by a plurality of variable factors and a cash flow model, the method comprising the steps of:
(a) initializing said factors and a figure of merit;
(b) varying each of said factors of the cash flow model;
(c) determining a gradient indicative of the size and direction of movement in response to said step (b);
(d) iteratively repeating said steps (b) and (c) until said gradient is less than a predetermined tolerance value;
(e) determining whether the results of the rating are within said figure of merit;
(f) when the results of the rating are determined to be outside of said figure of merit at said step (e), mutating at least one of said factors and repeating said steps (b)-(e); and
(g) when the results of the rating are determined to be within said figure of merit at said step (e), evaluating the structure of the results.
